(19) United States
(12) Patent Application Publication
(10) Pub. No.: US 2026/0220420 A1
(43) Pub. Date: Jul. 30, 2026

(54) METHOD TO ENHANCE NETWORK PERFORMANCE USING A TASK-AGNOSTIC GRAPH ABSTRACTION AND AFMS

(71) Applicant: Dell Products L.P., Round Rock, TX (US)

(72) Inventors: Gwenael Poitau, Montreal (CA); Ibrahim Abu Alhaol, Nepean (CA); Javad Mirzaei, Toronto (CA); Rohit Arora, San Jose, CA (US); Said Tabet, Austin, TX (US)

(21) Appl. No.: 19/039,460

(22) Filed: Jan. 28, 2025

(51) Int. Cl. G06N 3/042; H04L 41/14

(52) U.S. Cl. CPC G06N 3/042; H04L 41/145

(57) ABSTRACT

One example method includes generating an enhanced network graph (ENG) that is a representation of a physical RAN, providing the ENG as input to a GNN model, with the GNN model, using the ENG, to obtain network state embeddings of the physical RAN, providing the network state embeddings and a cluster of network task requests to a prompt generator, by the prompt generator, creating a prompt based on the network state embeddings and network task requests, transmitting the prompt to an AFM (agentic foundation model), based on the prompt, capturing, by the AFM, entity interdependencies of the physical RAN, transmitting the prompt, by the AFM, to a cluster of downstream tasks that each correspond to a respective one of the network task requests, and by the cluster of downstream tasks, generating respective control commands and transmitting the control commands to the physical RAN.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights.

### TECHNOLOGICAL FIELD OF THE DISCLOSURE

Embodiments disclosed herein generally relate to wireless networks. More particularly, at least some embodiments relate to systems, hardware, software, computer-readable media, and methods, for the use of GNNs (graph neural networks) to enhance network performance using a task-agnostic graph abstraction and AFM (agentic foundation model) reference architecture.

### BACKGROUND

Existing GNN modelling techniques while somewhat successful in some domains, still fall short in wireless applications such as, for example, a heterogenous, and large, wireless network, such as a telco network for example. This is due at least in part to the extensive dependencies among the network components. as well as to the physical environment. In particular, such GNNs require careful model design, feature engineering, and training to capture the complex inter-dependencies among the network components. Moreover, GNNs are mainly designed for a single specific downstream task. Thus, in conventional approaches, a GNN must be re-designed, and re-trained, for each new task to be accomplished in the wireless network.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses a graph indicating the development of LLMs (large language models) and their components in recent years.

FIG. 2 discloses aspects of an AFM (agentic foundation model) reference architecture.

FIG. 3 discloses a comparative example of GNN implementation in a wireless network.

FIG. 4 discloses an example schema, comprising a method and architecture, according to one embodiment.

FIG. 5 discloses an implementation of an enhanced GNN model deployed in a wireless communication network, according to one embodiment.

FIG. 6 discloses an example computing entity configured and operable to perform any of the disclosed methods, processes, and operations.

### DETAILED DESCRIPTION OF SOME EXAMPLE EMBODIMENTS

Embodiments disclosed herein generally relate to wireless networks. More particularly, at least some embodiments relate to systems, hardware, software, computer-readable media, and methods, for the use of GNNs (graph neural networks) to enhance network performance using a task-agnostic graph abstraction and AFM (agentic foundation model) reference architecture.

One or more example embodiments may comprise a method and/or architecture to enhance the performance of a network, such as a wireless communication network in the form of a RAN (radio access network) or O-RAN (open radio access network) for example, performance using a task-agnostic graph abstraction, and one or more AFMs. In an embodiment, a GNN may be employed for handling a variety of different tasks. Because the GNN may be task-agnostic, the GNN may not require reconfiguration, or retraining, to perform a new task not currently performed by the GNN and/or for which the GNN is not configured.

One example embodiment may comprise various operations, including: constructing an enhanced network graph based on attributes of a physical RAN – the network graph, which may take the form of a KG (knowledge graph comprising nodes that each correspond to a respective network entity, and edges that indicate relationships between nodes connected by the edges) may be created using multi-modal information obtained from sources such as RF (radio frequency) signals, camera images, video data, and LiDAR (light detecting and ranging) images; feeding the network graph to a GNN model which uses the network graph to obtain, and output, network state embeddings; feeding the GNN output to a prompt generator which uses the GNN output to create a prompt; providing the prompt to an AFM; passing an output of the AFM, obtained as a result of the prompt, to a downstream task in a network automation platform, such as xAPP, rAPP, and/or dAPP; processing the AFM response for the downstream task; and, sending a control command, corresponding to the task, into the RAN.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments is that a GNN may be employed for decision making that is agnostic as to the particular task(s) which are to be implemented in a communication network. An embodiment may eliminate any need to separately retrain one or more GNNs for each different downstream task to be performed in a communication network. An embodiment may effectively and efficiently capture node interdependencies of a large scale, and complex, RAN, so as to serve various downstream tasks. Various other advantages of one or more example embodiments will be apparent from this disclosure.

### A. Example context for one or more embodiments

One or more embodiments may apply GenAI (generative artificial intelligence) in the context of communication network environments, such as an O-RAN for example. In this regard, AI/ML (artificial intelligence / machine learning) for communication applications and environments, such as O-RANs for example, faces various challenges, particularly in large scale deployments. Such challenges include generalization limitations, such as for new network topologies and conditions, and obtaining proper coordination of multi multi-vendor multi multi-agent solutions.

However, it may be expected that recent progress on GenAI, and LLMs in particular, will open a new era in wireless network optimization by providing unprecedented orchestration and generalization capabilities. In the longer term, GenAI may also help to shape new 6G, and subsequent, paradigms such as semantic communications.

Moreover, the approach to telecom standardization may change, possibly significantly. For example, instead of specifying granular elements of network protocols, new telecom standardization approaches may move instead towards only defining high level concepts, such as slicing for example, and leaving the lower-level granular implementation to GenAI platforms.

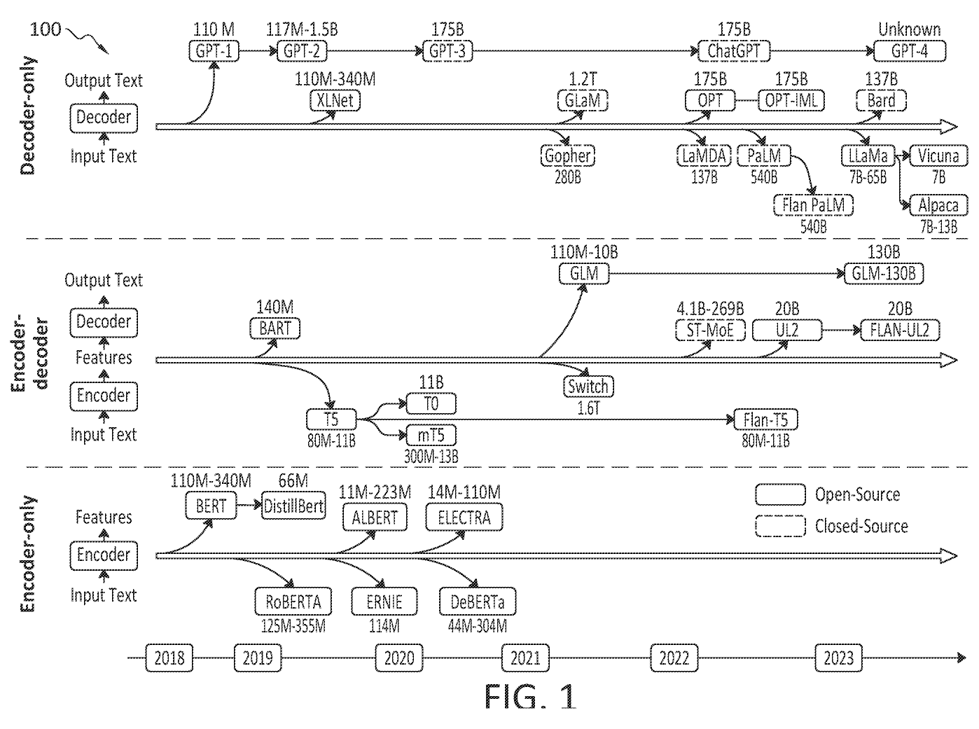

As shown in the example graph 100 disclosed in FIG. 1, the size and architecture of LLMs has progressed significantly between 2018 and 2023. This is particularly true in the areas of encoder-decoder developments, and decoder-only developments. For example, GPT-1 was a key technology in 2018, but has been overtaken by GPT-4 as of 2023. By way of contrast, the pace of development of encoder-only platforms has been somewhat slower than that of the decoder-only platforms, and slower than that of the encoder-decoder platforms.

### B. Introduction – Telco Agentic Foundation Model AFM

One or more embodiments may employ an AFM in the context of O-RAN operations. As used herein, a Telco Agentic Foundation Model (AFM) may comprise a GenAI module fine-tuned on telecom data which may include multiple functions to support its decision-making ability including, but not limited to, specialized AI/ML agents, knowledge base, and digital twins. One or more embodiments may employ such a GenAI module for functions including, but not limited to, prompt generation, and network configuration definition and refinement.

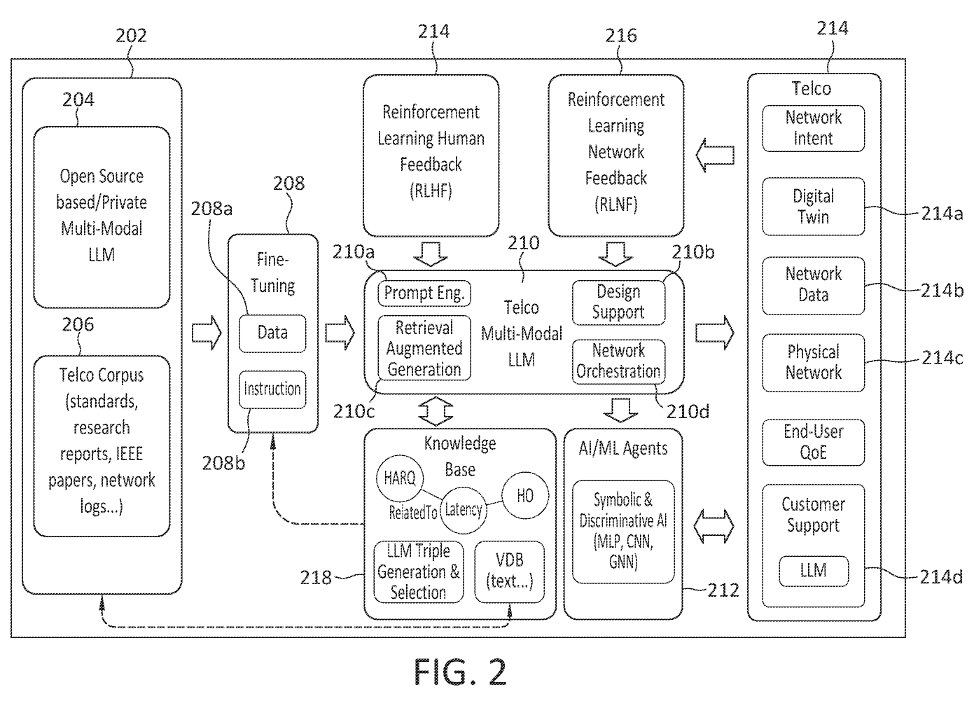

With reference now to FIG. 2, an example AFM reference architecture 200, in which one or more example embodiments may be implemented, is disclosed. This example AFM reference architecture 200 describes various processes and interactions between various components and agents leveraging different knowledge bases, and implementing multiple different LLM instances tuned to achieve specific objectives. Such objectives may include, for example, network operations, network DT (digital twin) and data management, GNN (Graph Neural Network) for network optimization, customer support, and performance evaluation and training.

In more detail, the example architecture 200 may comprise various inputs 202 such as a base-level LLM 204 which may take the form of an open source based/private multi-modal LLM, and various information 206 such as a telco corpus for example. The inputs 202 may be provided to a fine-tuning module 208 that may tune the base-level LLM 204 to create a more specific LLM implementation, such as a telco, or O-RAN, multi-modal LLM 210. In addition to the inputs 202, the fine-tuning module 208 may also comprise a dataset 208a, and various instructions 208b, which may both be used in a fine tuning process.

The multi-modal LLM 210 may operate to define, and orchestrate, such as in cooperation with one or more AI/ML agents 212, one or more elements of a network configuration 214, or elements of an O-RAN. To these, and other, ends, the multi-modal LLM 210 may comprise various components, such as prompt engineering 210a, design support 210b, RAG 210c, and a network orchestration module 210d. In connection with its operations, the multi-modal LLM 210 may receive various inputs, such as reinforcement learning human feedback 214, and reinforcement learning network feedback 216, both of which may be used by the multi-modal LLM 210 to define, implement, and refine, the network configuration 214. Further, the reinforcement learning feedback, as well as historical log information concerning usage and configuration of networks, may be used to generate forecasts as to changes to the configuration, and use, of one or more private networks. As well, the multi-modal LLM 210 may draw from, and make deposits to, a knowledge base 218, concerning the operations of the multi-modal LLM 210.

Finally, the network configuration 214 may comprise various elements. Such elements may include, but are not limited to, a digital twin 214a, network data 214b concerning network operations, events, and configurations, a physical communication network 214c, and a customer support module 214d which may comprise, for example, a virtual assistant such as a chatbot that comprises an LLM.

### C. Detailed discussion

### C.1 Introduction

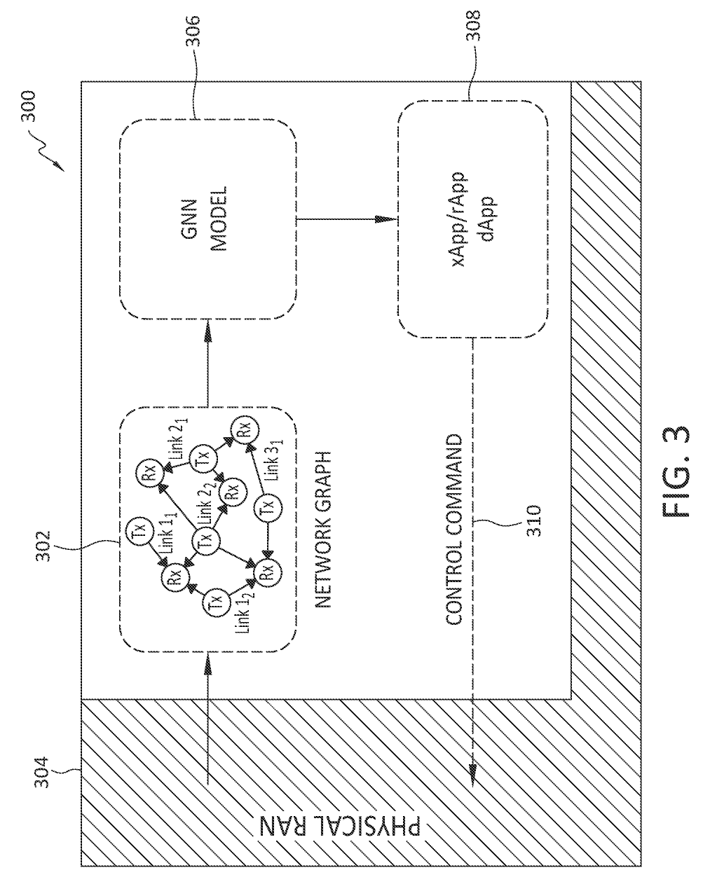

With attention now to FIG. 3, a comparative example of a schema 300 is provided which, considered together with the rest of this disclosure, may help to illustrate some useful features and aspects of one or more embodiments. As shown there, a network graph 302 may be generated based on a physical RAN 304. As noted earlier herein, a network graph may comprise a KG that represents network entities as nodes, and relationships between the entities are represented as edges connecting the nodes. In an embodiment, each node and edge has a corresponding set of features comprised of RF KPIs (key performance indicators) as well as the multi-modal KPIs collected from the physical RAN 304.

The network graph 302 may be provided as an input to a GNN model 306 configured for a particular task that is to be implemented in the physical RAN 304. The GNN model 306 may use the network graph 302 to output parameters of the task to one or more network automation apps 308. The network automation apps 308 may translate the task parameters into one or more control commands 310 which may then be sent to the physical RAN 304 for implementation of the task.

In this comparative example, the GNN model 306 is only configured to perform the designated task. Any new or modified tasks required to be implemented in the physical RAN 304 would require a re-configuration, and retraining, of the GNN model 306. Notably, as well, the example schema 300 lacks an AFM and its associated functionality.

### C.2 Aspects of an example method and architecture

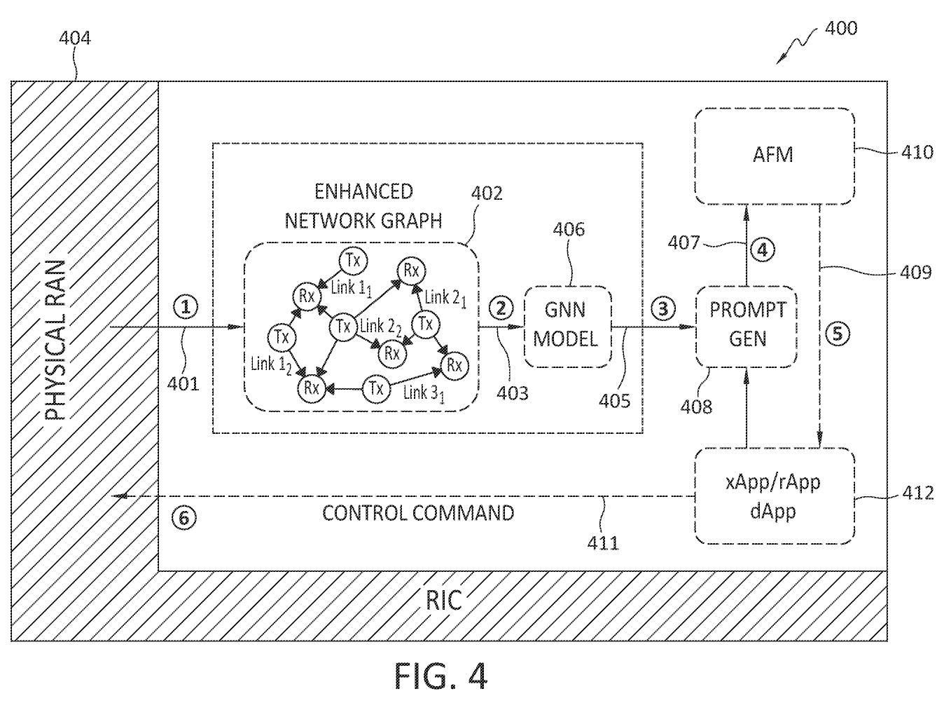

With attention next to FIG. 4, an example schema 400 according to one embodiment is disclosed. The following discussion will address operations of an example method according to one embodiment, with reference to various architectural elements.

As shown in FIG. 4, an example method may begin with construction 401 of an enhanced network graph (ENG) 402 based on attributes of a communication network, such as RF signals and multi-modal data (2D Lidar images and sensor data, from a physical RAN 404. In an embodiment, the ENG 402 may take the form of a KG that describes fact and conventions in the network as well as the upstream and down stream relations among the network components. This for example includes nodes that each correspond to a particular network entity, which may comprise hardware and/or software, and also includes edges that describe relationships between the nodes that they connect. It is noted that as used herein, a ‘network entity’ may comprise any system or component, whether comprised of hardware and/or software, that may be included in, or at least play a role in, a wireless communication network. As such, and solely for the purposes of illustration, network entities may comprise, but are not limited to, cameras both still and video, LiDAR systems, transmitters, receivers, routers, servers, computing devices of any kind, repeaters, antennas, cell phone towers, and mobile phones, for example.

In an embodiment, the ENG 402 may be constructed using, and may comprise, multi-modal information from and/or about a variety of sources. Such sources may include, but are not limited to, RF signals, camera images, video data, LiDAR images, and sensor data measurements from IoT devices.

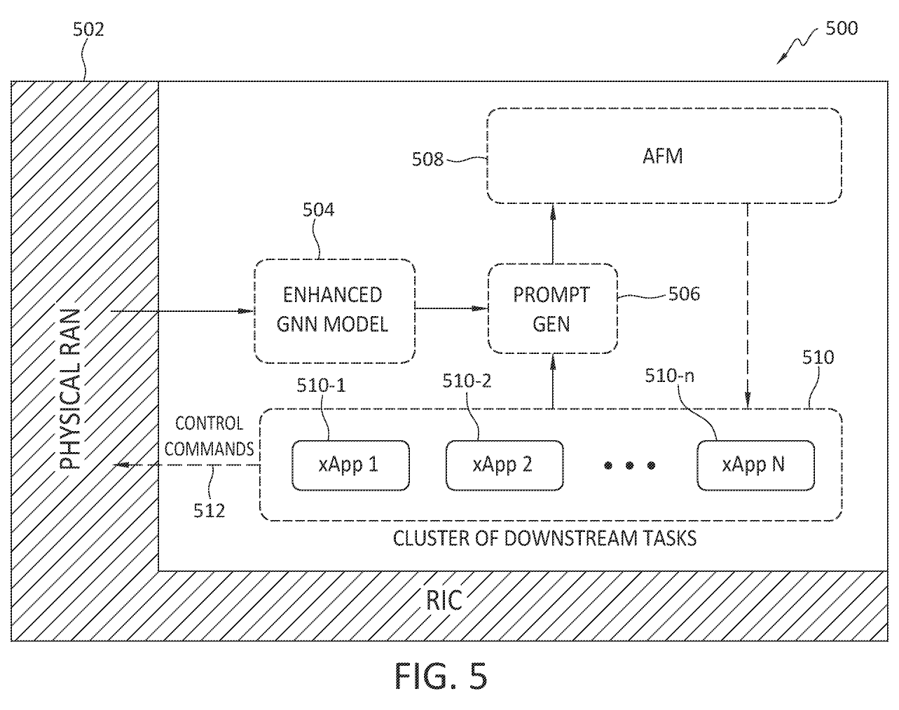

The ENG 402 may then be provided 403 as an input to a GNN model 406. In an embodiment, the combination of the ENG 402 and the GNN model 406 may be considered as an ‘enhanced GNN model,’ another example of which is discussed below in connection with FIG. 5.

In an embodiment, the GNN model 406 may not be configured to perform any particular task(s), but may instead be task-agnostic. The GNN model 406 may use the input ENG 402 to generate, and output, network state embeddings that comprise combinations of both RF KPIs and multi-modal network KPIs of particular features of the physical RAN 404, such as structural features of the physical RAN 404, to elements, such as the nodes and edges, of the ENG 402.

The output of the GNN model 406, that is, the network state embeddings, may then be provided 405 to a prompt generator 408, which may take the form of a prompt generator engine in one embodiment. In addition to the GNN model 406 output, a request, which may identify a particular task, or tasks, to be performed, from xApp/rApp/dApp, or simply ‘request,’ may also be provided to the prompt generator 408.

Briefly, an xAPP refers to an application that may have to execute in near-real time, while an rAPP refers to an application that executes more slowly, that is, in non-real time. By way of example, an xAPP may be an application that handles handovers in a cell network – since one aim may be to provide uninterrupted service for a caller, the xAPP handling handovers should operate in near-real time. As another example, an rAPP may be an application that controls cell tower transmission power – in many networks, the transmission power may not need to change quickly, and as such, the rAPP may operate more slowly than an xAPP, that is, in non-real time. Finally, a dAPP refers to a decentralized application that uses a group of computing devices to provide one or more services, such as network security for example.

The prompt generator 408 may then use the GNN model 406 output to create a prompt, which may be provided 407 to an AFM 410, another example of which is disclosed in FIG. 2. The AFM 410 may act on the prompt, which may include or reference the network state embeddings described above, and possibly using a self-attention mechanism, capture entity interdependencies of the physical RAN 404 such as may be needed by one or more downstream tasks. The entity interdependencies obtained by the AFM 410 in response to the prompt may then be transmitted 409 to a downstream task in a network platform 412, such as xAPP, rAPP, and/or dAPP. The network platform 412 may process the information received from the AFM 410 and generate, and transmit, a control command 411, corresponding to the task(s) to be performed, to the physical RAN 404. The control command(s) 411 may then be executed by one or more network elements to perform the task(s) in the physical RAN 404.

With reference next to FIG. 5, an example schema 500 according to one embodiment is disclosed. As shown, the schema 500 may comprise a physical RAN 502, enhance GNN model 504, prompt generator 506, and AFM 508. In one embodiment, any one or more of these components may have similar, or identical, features and functionalities to their counterparts in FIG. 4.

As shown in the example FIG. 5, information generated by the AFM 508 based on a prompt received from the prompt generator 506 may be passed to a cluster 510 of downstream tasks 510-1, 510-2…510-n that are to be performed in the physical RAN 502. Each of the tasks in the cluster 510 may generate a respective control command 512 which may be transmitted, synchronously or asynchronously, to the physical RAN 502. The various control commands 502 may perform, and/or cause the performance of, the various tasks in the physical RAN 502.

It is noted with respect to the example of FIG. 5 at least, that a single, task-agnostic enhanced GNN model 504 may be used to effect the implementation of multiple different tasks, exemplified by the cluster 510, in the physical RAN 502. Advantageously, the same GNN model 504 may be used for all of the tasks, without requiring reconfiguration or retraining of the GNN model 504 to suit the various different tasks.

### C.3 Further discussion

As disclosed herein, one or more embodiments may comprise various useful features and aspects, although no embodiment is required to possess any of such features or aspects. The following examples are illustrative, but not exhaustive.

In an embodiment, an enhanced GNN model is agnostic to downstream tasks and only embeds the network features in a latent space. As such, an embodiment may eliminate the need to re-train GNNs for each downstream task separately. In an embodiment, using network feature embedding, and leveraging a self-attention mechanism of an AFM, the AFM can efficiently capture the inter-dependencies in a large scale and complex RAN to serve the downstream tasks. An embodiment may provide flexibility and generalizability in serving various downstream tasks. An embodiment may implement customization on prompts based on the parameters and features of the planned downstream tasks. Finally, a single AFM may serve a cluster of downstream tasks.

### D. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. Further Example Embodiments

Following are some further example embodiments. These are presented only by way of example and are not intended to limit the scope of this disclosure or the claims in any way.

Embodiment 1. A method, comprising: generating an enhanced network graph that comprises a representation of a physical RAN (radio access network); providing the enhanced network graph as input to a GNN (graph neural network) model; with the GNN model, using the enhanced network graph, to obtain network state embeddings of the physical RAN; providing the network state embeddings and a cluster of network task requests to a prompt generator; by the prompt generator, creating a prompt based on the network state embeddings and network task requests; transmitting the prompt to an AFM (agentic foundation model); based on the prompt, capturing, by the AFM, entity interdependencies of the physical RAN; transmitting the prompt, by the AFM, to a cluster of downstream tasks that each correspond to a respective one of the network task requests; and by the cluster of downstream tasks, generating respective control commands and transmitting the control commands to the physical RAN.

Embodiment 2. The method as recited in any preceding embodiment, wherein the enhanced network graph comprises nodes that each represent a respective entity of the physical RAN, and further comprises edges that connect the nodes and represent relationships between nodes that are so connected.

Embodiment 3. The method as recited in any preceding embodiment, wherein the GNN model is task-agnostic.

Embodiment 4. The method as recited in any preceding embodiment, wherein the control commands are executable in the physical RAN to implement the network tasks.

Embodiment 5. The method as recited in any preceding embodiment, wherein the downstream tasks in the cluster correspond to one of an xAPP, an rAPP, or a dAPP.

Embodiment 6. The method as recited in any preceding embodiment, wherein the network state embeddings comprise respective correlations of particular features of the physical RAN to elements of the enhanced network graph.

Embodiment 7. The method as recited in embodiment 6, wherein the GNN model embeds the features of the physical RAN in a latent space.

Embodiment 8. The method as recited in any preceding embodiment, wherein the GNN model does not need to be individually trained for each of the downstream tasks.

Embodiment 9. The method as recited in any preceding embodiment, wherein addition of a new downstream task to the cluster of downstream tasks does not require reconfiguration or retraining of the GNN model.

Embodiment 10. The method as recited in any preceding embodiment, wherein the control commands are executed in the physical RAN to implement the network tasks.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

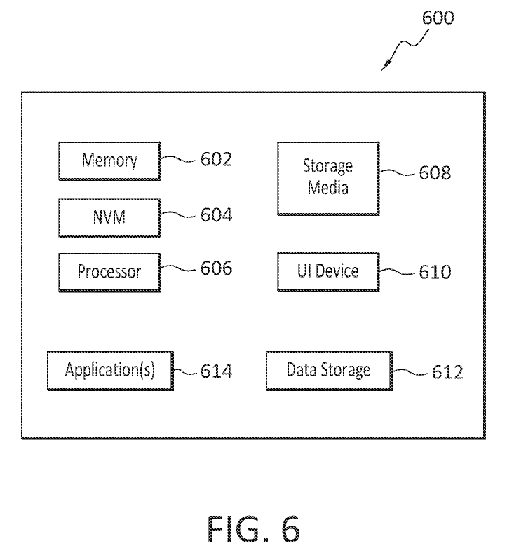

With reference briefly now to FIG. 6, any one or more of the entities disclosed, or implied, by FIGS. 1-5, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
generating an enhanced network graph that comprises a representation of a physical RAN (radio access network);
providing the enhanced network graph as input to a GNN (graph neural network) model;
with the GNN model, using the enhanced network graph, to obtain network state embeddings of the physical RAN;
providing the network state embeddings and a cluster of network task requests to a prompt generator;
by the prompt generator, creating a prompt based on the network state embeddings and network task requests;
transmitting the prompt to an AFM (agentic foundation model);
based on the prompt, capturing, by the AFM, entity interdependencies of the physical RAN;
transmitting the prompt, by the AFM, to a cluster of downstream tasks that each correspond to a respective one of the network task requests; and
by the cluster of downstream tasks, generating respective control commands and transmitting the control commands to the physical RAN.

2. The method as recited in claim 1, wherein the enhanced network graph comprises nodes that each represent a respective entity of the physical RAN, and further comprises edges that connect the nodes and represent relationships between nodes that are so connected.

3. The method as recited in claim 1, wherein the GNN model is task-agnostic.

4. The method as recited in claim 1, wherein the control commands are executable in the physical RAN to implement the network tasks.

5. The method as recited in claim 1, wherein the downstream tasks in the cluster correspond to one of an xAPP, an rAPP, or a dAPP.

6. The method as recited in claim 1, wherein the network state embeddings comprise respective correlations of particular features of the physical RAN to elements of the enhanced network graph.

7. The method as recited in claim 6, wherein the GNN model embeds the features of the physical RAN in a latent space.

8. The method as recited in claim 1, wherein the GNN model does not need to be individually trained for each of the downstream tasks.

9. The method as recited in claim 1, wherein addition of a new downstream task to the cluster of downstream tasks does not require reconfiguration or retraining of the GNN model.

10. The method as recited in claim 1, wherein the control commands are executed in the physical RAN to implement the network tasks.

11. A non-transitory storage medium having stored therein instructions that are executable by one or more hardware processors to perform operations comprising:
generating an enhanced network graph that comprises a representation of a physical RAN (radio access network);
providing the enhanced network graph as input to a GNN (graph neural network) model;
with the GNN model, using the enhanced network graph, to obtain network state embeddings of the physical RAN;
providing the network state embeddings and a cluster of network task requests to a prompt generator;
by the prompt generator, creating a prompt based on the network state embeddings and network task requests;
transmitting the prompt to an AFM (agentic foundation model);
based on the prompt, capturing, by the AFM, entity interdependencies of the physical RAN;
transmitting the prompt, by the AFM, to a cluster of downstream tasks that each correspond to a respective one of the network task requests; and
by the cluster of downstream tasks, generating respective control commands and transmitting the control commands to the physical RAN.

12. The non-transitory storage medium as recited in claim 11, wherein the enhanced network graph comprises nodes that each represent a respective entity of the physical RAN, and further comprises edges that connect the nodes and represent relationships between nodes that are so connected.

13. The non-transitory storage medium as recited in claim 11, wherein the GNN model is task-agnostic.

14. The non-transitory storage medium as recited in claim 11, wherein the control commands are executable in the physical RAN to implement the network tasks.

15. The non-transitory storage medium as recited in claim 11, wherein the downstream tasks in the cluster correspond to one of an xAPP, an rAPP, or a dAPP.

16. The non-transitory storage medium as recited in claim 11, wherein the network state embeddings comprise respective correlations of particular features of the physical RAN to elements of the enhanced network graph.

17. The non-transitory storage medium as recited in claim 16, wherein the GNN model embeds the features of the physical RAN in a latent space.

18. The non-transitory storage medium as recited in claim 11, wherein the GNN model does not need to be individually trained for each of the downstream tasks.

19. The non-transitory storage medium as recited in claim 11, wherein addition of a new downstream task to the cluster of downstream tasks does not require reconfiguration or retraining of the GNN model.

20. The non-transitory storage medium as recited in claim 11, wherein the control commands are executed in the physical RAN to implement the network tasks.
